(19) United States
(12) Patent Application Publication
(10) Pub. No.: US 2020/0085080 A1
(43) Pub. Date: Mar. 19, 2020

(54) COMPOSITIONS AND METHODS FOR COATING DRY PET FOOD KIBBLE

(71) Applicant: Société des Produits Nestlé S.A., Vevey (CH)

(72) Inventors: Maquel Deckard, St. Louis, MO (US); Jean Luz Rayner, St. Joseph, MO (US); Michael G. Rayner, St. Joseph, MO (US); Peggy Haukap, Alhambra, IL (US)

(21) Appl. No.: 16/686,987

(22) Filed: Nov. 18, 2019

Related U.S. Application Data
(63) Continuation of application No. 14/539,471, filed on Nov. 12, 2014, now abandoned.
(60) Provisional application No. 61/905,482, filed on Nov. 18, 2013.

(51) Int. Cl. A23K 40/25; A23K 20/20; A23K 40/20; A23K 50/42; A23K 10/30; A23K 20/174; A23K 40/30; A23K 20/179; A23K 20/163; A23K 10/20; A23K 50/48; A23K 10/16

(52) U.S. Cl. CPC A23K 40/25; A23K 20/20; A23K 40/20; A23K 50/42; A23K 10/30; A23K 10/16; A23K 40/30; A23K 20/179; A23K 20/163; A23K 10/20; A23K 50/48; A23K 20/174

(57) ABSTRACT

Compositions and methods are provided for evenly coating or glazing dry pet food kibbles for improved palatability without loss of crunchiness of the dry kibbles over an extended time period. The coating compositions comprise water and at least one of a gum or a modified starch. The coating composition can comprise an additional ingredient such as one or more of a flavor, a color, an emulsified or particulate meat, an emulsified or particulate fruit or vegetable, an antioxidant, a vitamin, a mineral, a non-replicating microorganism, a fiber or a prebiotic. In an embodiment, the coating composition can include dextrose and/or glycine. After mixing and retorting, the coating composition can be a viscous paste with a viscosity of 2500 to 4000 centipoises, preferably 3000 to 3500 centipoises, as measured at room temperature.

### PRIORITY CLAIM

This application is a continuation of U.S. application Ser. No. 14/539,471 filed Nov. 12, 2014, which claims priority to Provisional Appl. Ser. No. 61/905,482 filed Nov. 18, 2013. The entire contents of the above-referenced patent applications are hereby expressly incorporated herein by reference.

### BACKGROUND

The present disclosure generally relates to pet foods. More specifically, the present disclosure relates to compositions and methods for coating or glazing dry pet food kibbles.

Currently there are wet pet food products that have the form of loaf or the form of chunk in gravy in the market. However, these products are intended for an entire meal occasion and cannot evenly coat dry pet food. The loaf product is too hard to mix with dry pet food, and the chunk in gravy product soaks the dry pet food. Another type of pet food on the market, the SMART PUP product, is considered a treat and can be served as a frozen puck or fed to the pet straight out of the container.

Furthermore, few products currently on the market are formulated and advertised as just an enhancement to dry pet food. Of the main pet food categories, namely dry, semi-moist, and wet, dry pet foods are perceived as the least palatable. Pet owners can add wet pet food to dry food pet food at the time of feeding. Such treatment improves the palatability of the dry pet food and is pleasing to the pet owner and/or the pet. However, the benefit is lost very quickly, typically within minutes, because the wet pet food is readily absorbed by the dry pet food causing the dry pet food to lose crunchiness and become soggy, messy and unappealing.

### SUMMARY

The present disclosure provides compositions and methods for evenly coating or glazing dry pet food kibbles for improved palatability without loss of crunchiness of the dry kibbles over an extended time period. The coating compositions comprise water and at least one of a gum or a modified starch. After mixing and retorting, the coating composition can be a viscous paste with a viscosity of 2500 to 4000 centipoises, preferably 3000 to 3500 centipoises, as measured at room temperature.

Accordingly, in a general embodiment, the present disclosure provides a coating composition that is a wet food product comprising water and an ingredient selected from the group consisting of a modified starch, a gum, and a combination thereof. The composition has a viscosity of 2500 to 4000 centipoises as measured at room temperature.

In an embodiment, the coating composition further comprises an additional ingredient selected from the group consisting of a flavor, a color, an antioxidant, a vitamin, a mineral, a non-replicating microorganism, a fiber, a prebiotic, and combinations thereof.

In an embodiment, the coating composition further comprises an additional ingredient selected from the group consisting of an emulsified or particulate meat, an emulsified or particulate fruit, an emulsified or particulate vegetable, and combinations thereof.

In an embodiment, the coating composition further comprises at least one of dextrose or glycine.

In an embodiment, the viscosity is 3000 to 3500 centipoises as measured at room temperature.

In another embodiment, the present disclosure provides a method of making a coating composition. The method comprises: mixing water and an ingredient selected from the group consisting of a modified starch, a gum, and a combination thereof to form a mixture; heating the mixture; and pouring the heated mixture into a container that is then retorted, the retorted mixture has a viscosity of 2500 to 4000 centipoises as measured at room temperature.

In an embodiment, the mixture is heated to a temperature of at least 180° F. before pouring into the container.

In an embodiment, the heated mixture is homogenized before pouring into the container. At least one of a particulate fruit or a particulate vegetable can be added to the mixture after homogenizing.

In an embodiment, a particulate meat is added to the mixture before the heating.

In another embodiment, the present disclosure provides a method for preparing a pet food. The method comprises adding a wet food product to a dry food product. The wet food product comprises water and an ingredient selected from the group consisting of a modified starch, a gum, and a combination thereof and having a viscosity of 2500 to 4000 centipoises as measured at room temperature.

In an embodiment, 10% to 15% of the wet food product is added to 85% to 90% dry food product, in reference to a final weight of the pet food.

In an embodiment, the dry food product comprises individual pieces, and the wet food product is added to the dry food product to coat each of the individual pieces of the dry food product with the wet food product.

In an embodiment, the individual pieces of the dry food product are coated with the wet food product without the individual pieces sticking together.

In an embodiment, the method further comprises administering to a companion animal the pet food formed by addition of the wet food product to the dry food product.

In an embodiment, the dry food product maintains about the same maximum compressive force without breaking for at least 2.5 hours after addition of the wet food product.

In another embodiment, the present disclosure provides a pet food comprising a dry food product; and a coating composition on the dry food product. The coating composition is a wet food product comprising water and an ingredient selected from the group consisting of a modified starch, a gum, and a combination thereof. The coating composition has a viscosity of 2500 to 4000 centipoises as measured at room temperature.

In an embodiment, the dry food product has a form of kibbles.

In an embodiment, an amount of the coating composition is 10% to 15% and an amount of the dry food product is 85% to 90%, in reference to a total weight of the pet food.

In another embodiment, the present disclosure provides a kit comprising a wet food product stored separately from a dry food product. The wet food product comprises water and an ingredient selected from the group consisting of a modified starch, a gum, and a combination thereof and has a viscosity of 2500 to 4000 centipoises as measured at room temperature.

In another embodiment, the present disclosure provides a pet feeding system comprising a plurality of pet food coating compositions. Each of the coating compositions is a wet food product comprising water and an ingredient selected from the group consisting of a modified starch, a gum, and a combination thereof and having a viscosity of 2500 to 4000 centipoises as measured at room temperature. A first subset of the coating compositions has a different texture relative to a second subset of the coating compositions.

An advantage of the present disclosure is to enable a consumer to evenly coat dry pet food with a wet food product.

Another advantage of the present disclosure is to enable a consumer to coat dry pet food with a wet food product having a different texture than the dry food product.

Still another advantage of the present disclosure is to enable a consumer to coat dry pet food with a wet food product without affecting the crunchiness of the dry pet food.

Yet another advantage of the present disclosure is to enable a consumer to coat dry pet food with a wet food product while delivering a nutritional benefit.

An additional advantage of the present disclosure is to enable a consumer to evenly coat dry pet food kibbles without clumping, for example with the kibbles remaining as individual pieces that do not stick together.

Another advantage of the present disclosure is to provide a wet coating for dry pet food kibbles that is not runny or watery in texture.

Still another advantage of the present disclosure is to provide a wet coating for dry pet food kibbles that has a nappe and will cover a spoon.

Yet another advantage of the present disclosure is to coat a dry pet food kibble such that the kibble does not get soggy or lose crunchiness for at least 2.5 hours.

Still another advantage of the present disclosure is to coat a dry pet food kibble with a composition that can be fortified with antioxidants, vitamins, minerals, non-replicating microorganisms, prebiotics and/or fiber.

Yet another advantage of the present disclosure is to improve the palatability and/or acceptance of dry pet food relative to the dry pet food alone.

An additional advantage of the present disclosure is to provide different coatings having a texture that is smooth, fine particulate, chunky or a combination thereof to enable a customer to choose a texture that best fits the needs and preferences of a pet.

Another advantage of the present disclosure is to provide a wet pet food that can be combined with dry pet food and maintain palatability, texture, and appealing appearance of the resultant combination for longer times relative to mixtures of known wet pet foods with dry pet food.

Additional features and advantages are described in, and will be apparent from, the following Detailed Description and the FIGURES.

### BRIEF DESCRIPTION OF THE DRAWINGS

FIG. 1 is a photograph of dry kibbles coated with an embodiment of the wet food composition provided by the present disclosure.

### DETAILED DESCRIPTION

The term “pet” means any animal which could benefit from or enjoy the compositions provided by the present disclosure. The pet can be an avian, bovine, canine, equine, feline, canine, lupine, murine, ovine, or porcine animal. The pet can be any suitable animal, and the present disclosure is not limited to a specific pet animal. The term “companion animal” means a dog or a cat.

The term “pet food” means any composition intended to be consumed by a pet.

“Wet food” is pet food having a moisture content from about 50% to about 90%, preferably from about 70% to about 90%. “Dry food” is pet food having a moisture content less than about 20%, preferably less than about 15%, more preferably less than about 10%. “Kibbles” are pellets of dry pet food. “Semi-moist food” is pet food having a moisture content from about 20% to about 50%, preferably from about 25% to about 35%.

The term “single package” means that the components of a kit are physically associated in or with one or more containers and considered a unit for manufacture, distribution, sale, or use. Containers include, but are not limited to, bags, boxes, cartons, bottles, packages of any type or design or material, over-wrap, shrink-wrap, affixed components (e.g., stapled, adhered, or the like), or combinations thereof. A single package may be containers of individual components physically associated such that they are considered a unit for manufacture, distribution, sale, or use.

The term “virtual package” means that the components of a kit are associated by directions on one or more physical or virtual kit components instructing the user how to obtain the other components, e.g., a bag or other container containing one component and directions instructing the user to go to a website, contact a recorded message or a fax-back service, view a visual message, or contact an instructor to obtain instructions on how to use the kit or safety or technical information about one or more components of a kit.

All percentages expressed herein are by weight of the total weight of the composition unless expressed otherwise. As used herein and in the appended claims, the singular form of a word includes the plural, and vice versa, unless the context clearly dictates otherwise. Thus, the references “a,” “an” and “the” are generally inclusive of the plurals of the respective terms. For example, reference to “a measuring device” or “a method” includes a plurality of such “measuring devices” or “methods.” Similarly, the words “comprise,” “comprises,” and “comprising” are to be interpreted inclusively rather than exclusively. Likewise, the terms “include,” “including” and “or” should all be construed to be inclusive, unless such a construction is clearly prohibited from the context. However, the embodiments provided by the present disclosure may lack any element that is not specifically disclosed herein. Thus, a disclosure of an embodiment defined using the term “comprising” also is a disclosure of embodiments “consisting essentially of and “consisting of the disclosed components. Where used herein, the term “example,” particularly when followed by a listing of terms, is merely exemplary and illustrative, and should not be deemed to be exclusive or comprehensive.

The present disclosure provides compositions and methods for evenly coating or glazing dry pet food kibbles. The coating compositions comprise water and at least one of a gum or a modified starch. After mixing and retorting, the coating composition can be a viscous paste with a viscosity of 2500 to 4000 centipoises, preferably 3000 to 3500 centipoises, as measured at room temperature. The coating composition can comprise an additional ingredient such as one or more of a flavor, a color, an emulsified or particulate meat, an emulsified or particulate fruit, an emulsified or particulate vegetable, an antioxidant, a vitamin, a mineral, a non-replicating microorganism, a fiber or a prebiotic. In an embodiment, the coating composition can include dextrose and/or glycine. Depending on the size of particulates included in the coating composition, the coating composition can have a smooth texture, a fine particulate texture, a chunky texture or a combination thereof. In an embodiment, about 10% to 15% of the coating composition is mixed with about 85% to about 90% dry pet food kibbles until each kibble is completely coated.

Examples of suitable gums are gellan gum, xanthan gum, locust bean gum, pectin, carrageenan (e.g., kappa, iota and/or lambda), cellulose gum, gum Arabic and the like, and combinations thereof. Modified starch is prepared by treating starch physically, enzymatically or chemically, changing the properties of the starch. For example, starches may be modified to increase their stability against excessive heat, acid, shear; to change their texture; to decrease or increase the viscosity; to lengthen or shorten gelatinization time; or to increase the visco-stability. Non-limiting examples of suitable starch sources include wheat, barley, rye, rice, tapioca, potato and corn.

Non-limiting examples of suitable flavors include yeast, tallow, rendered animal meals (e.g., poultry, beef, lamb, pork), flavor extracts or blends (e.g., grilled beef), spices, and the like. Suitable spices include parsley, oregano, sage, rosemary, basil, thyme, chives and the like. Non-limiting examples of suitable colors include FD&C colors, such as blue no. 1, blue no. 2, green no. 3, red no. 3, red no. 40, yellow no. 5, yellow no. 6, and the like; natural colors, such as caramel coloring, annatto, chlorophyllin, cochineal, betanin, turmeric, saffron, paprika, lycopene, elderberry juice, pandan, butterfly pea and the like; titanium dioxide; and any suitable food colorant known to the skilled artisan.

Non-limiting examples of suitable meats for use as emulsified or particulate meat include poultry, beef, pork, lamb and fish, especially those types of meats suitable for pets. Any of the meats and meat by-products may be used, including meats such as whole-carcass beef and mutton; lean pork trim; beef shanks; veal; beef and pork cheek meat; and meat by-products such as lips, tripe, hearts, tongues, mechanically deboned beef, chicken or fish, beef and pork liver, lungs, kidneys, and the like. In an embodiment, the meat is a combination of different types of meats. The coating composition is not limited to a specific meat or combination of meats, and any meat known to the skilled artisan for making a food composition can be used.

Non-limiting examples of suitable vegetables for use as emulsified or particulate vegetables include potatoes, squash, zucchini, spinach, radishes, asparagus, tomatoes, cabbage, peas, carrots, spinach, corn, green beans, lima beans, broccoli, brussel sprouts, cauliflower, celery, cucumbers, turnips, yams, and combinations thereof. Non-limiting examples of suitable fruits for use as emulsified or particulate fruits include apple, orange, pear, peach, strawberry, banana, cherry, pineapple, pumpkin, kiwi, grape, blueberry, raspberry, mango, guava, cranberry, blackberry or combinations thereof. The coating composition is not limited to a specific emulsified or particulate fruit or vegetable or combination thereof, and any fruit or vegetable known to the skilled artisan for making a food composition can be used.

Non-limiting examples of suitable vitamins include vitamin A, any of the B vitamins, vitamin C, vitamin D, vitamin E, and vitamin K, including various salts, esters, or other derivatives of the foregoing. Non-limiting examples of suitable minerals include calcium, phosphorous, potassium, sodium, iron, chloride, boron, copper, zinc, magnesium, manganese, iodine, selenium, and the like. Non-limiting examples of suitable antioxidants include BHA/BHT, vitamin E (tocopherols), and the like.

Non-limiting examples of suitable fibers include digestible or indigestible, soluble or insoluble, fermentable or non-fermentable fibers. Preferred fibers are from plant sources such as marine plants but microbial sources of fiber may also be used. A variety of soluble or insoluble fibers may be utilized.

Non-limiting examples of suitable prebiotics include fructo-oligosaccharides, gluco-oligosaccharides, galacto-oligosaccharides, isomalto-oligosaccharides, xylo-oligosaccharides, soybean oligosaccharides, lactosucrose, lactulose, and isomaltulose. In an embodiment, the prebiotic is chicory root, chicory root extract, inulin, or combinations thereof. Generally, prebiotics are administered in amounts sufficient to positively stimulate the healthy microflora in the gut and cause these “good” bacteria to reproduce. Typical amounts are from about one to about 10 grams per serving or from about 5% to about 40% of the recommended daily dietary fiber for an animal.

Non-replicating micro-organisms include probiotic bacteria that are inactivated, dead, non-viable and/or present as fragments such as DNA, metabolites, cytoplasmic compounds, and/or cell wall materials. Non-limiting examples of suitable micro-organisms include Bifidobacteria, Lactobacilli, Propionibacteria, Streptococci, Lactococci, Enterococci, Escherichia and combinations thereof, for example one or more of Bifidobacterium longum, Bifidobacterium lactis, Bifidobacterium animalis, Bifidobacterium breve, Bifidobacterium infantis, Bifidobacterium adolescentis, Lactobacillus acidophilus, Lactobacillus casei, Lactobacillus paracasei, Lactobacillus salivarius, Lactobacillus reuteri, Lactobacillus rhamnosus, Lactobacillus johnsonii, Lactobacillus plantarum, Lactobacillus fermentum, Lactobacillus lactis, Lactobacillus helveticus, Streptococcus thermophilus, Lactococcus lactis, Lactococcus diacetylactis, Lactococcus cremoris, Lactobacillus bulgaricus, Lactobacillus helveticus, Lactobacillus delbrueckii, and Escherichia coli.

Selection of the amounts of each additional ingredient is known to skilled artisans. Specific amounts for each additional ingredient will depend on a variety of factors such as the ingredient included in the coating composition; the species of animal; the animal's age, body weight, general health, sex, and diet; the animal's consumption rate; the purpose for which the pet food is administered to the animal; and the like. Therefore, the identity and amounts of the additional ingredients may vary widely and may deviate from the preferred embodiments described herein.

The present disclosure also provides methods for making coating compositions for application to dry pet food. For a coating with a smooth texture, at least a portion of the ingredients may be used in the form of a powder. For a coating with a particulate texture, the corresponding ingredients, such as the meat, the fruit and/or the vegetable, may be ground to form the particulates. A blender can be used in one or more stages to obtain a homogenous mixture.

At least a portion of the water, at least one of a gum or a modified starch, and any additional ingredient can mixed together to form a slurry. In an embodiment, these ingredients are mixed together at ambient temperature, namely about 70° F. For ingredients in a larger form such that a coating with a chunky texture can be achieved, a higher temperature, such as about 95° F., can be used to mix the ingredients together. The slurry may be combined with any remaining water and heated, for example to a temperature of at least 180° F., such as at least 200° F. For a coating composition with a smooth or particulate texture, emulsification can then be performed. A portion of the ingredients can be added after any emulsification; for example, particulate fruits and/or particulate vegetables can be added to the emulsified mixture. The resultant wet pet food product can be filled into containers that are sealed and retorted, for example by heat treatment at a temperature of 250 to 270° F. for 10 to 60 minutes. Then the containers can be cooled, for example to ambient temperature.

Non limiting examples of suitable containers are retortable flexible pouches, glass jars, or retortable rigid plastic containers.

The present disclosure also provides methods for coating dry pet food. The methods comprise adding to a dry pet food any of the coating compositions disclosed herein or a coating composition made by any of the methods disclosed herein. In an embodiment, about 10% to 15% of the coating composition is mixed with about 85% to about 90% dry pet food kibbles, for example until each kibble is completely coated. The resultant food product can be administered to a pet, such as a companion animal. Preferably, the food product consists of the wet food product and the dry food product such that additional components are not added. The coating composition and the dry pet food can be provided in a single package that separates the two compositions such that the consumer can mix the coating composition onto the dry pet food after purchasing the package. In an embodiment, the coating composition and the dry pet food can be provided in a virtual package.

### EXAMPLES

By way of example and not limitation, the following non-limiting examples are illustrative of various embodiments provided by the present disclosure.

### Example 1

100 lbs. of a coating composition was made according to the formula shown in Table 1 and by the process that follows.

TABLE 1

| INGREDIENTS | lbs. |
|---|---|
| Modified Starch (cross-linked) | 4.0 |
| Dextrose | 0.3 |
| Glycine | 0.7 |
| Sodium Chloride | 0.85 |
| Peanut Butter | 0.2 |
| Color (caramel) | 0.15 |
| Water (ambient - 70° F.) | 20.0 |
| Water (205° F.) | 73.8 |
| TOTAL | 100.0 |

The dry ingredients and the peanut butter were measured and combined in a Cherry-Burrell stainless steel mixing tank. 20 lbs. of water at ambient temperature (70° F.) was added and mixing continued for 2 minutes to make a slurry.

Separately, 73.8 lbs. of tap water was placed in a steam jacketed stainless steel tank fitted with a Lightening Mixer and heated to 205° F. The slurry was then added to the heated water and mixed for 3 minutes to form a smooth and viscous but flowable mixture. This mixture was then filled into 425 mL metal cans, hermetically sealed, and retorted at 252° F. for 25 minutes then cooled to ambient temperature (about 70° F.).

The viscosity of the cooled product was measured with a Brookfield Viscometer Model RVDT V-IT Serial # D 16006 and spindle #5 at 30 rpm. The lid of the can was removed and the spindle was inserted into the product to depth indicated by the manufacturer's mark. The measured viscosity was 3230 centipoise.

### Example 2

One hundred (100) pounds of a fine particulate beef and carrot coating product was made with ingredients in the proportions shown in Table 2 and by the process that follows.

TABLE 2

| INGREDIENTS | lbs. |
|---|---|
| Beef & Beef By-Products | 32.0 |
| Chicken & Chicken By-Products | 8.0 |
| Modified Starch (cross-linked) | 2.5 |
| Vitamin Premix | 0.01 |
| Mineral Premix | 0.06 |
| Color (caramel) | 0.25 |
| Carrot (dehydrated/ground) | 2.0 |
| Water | 55.18 |
| TOTAL | 100.0 |

The beef and chicken ingredients were ground through a plate with ⅜ inch holes on a Weiler grinder. Amounts of each were weighed as shown in Table 2 and added to a Reitz ribbon blender. With continuous mixing, all the other ingredients in Table 2, except the carrots, were added. The mixture was cooked while being blended to a temperature of 180° F. The blend was then emulsified through a Karl Schnell emulsion mill through 10 and 8 mm plates.

The ground (100% through US 14 mesh) dehydrated carrot was added to the emulsified mixture. The moisture of the mixture was 82.83%. This mixture was then filled into 425 mL metal cans, hermetically sealed, and retorted at 252° F. for 25 minutes then cooled to ambient temperature (about 70° F.). The viscosity of the cooled product was measured as described in Example 1 and was 3450 centipoise.

### Example 3

One hundred (100) pounds of a fine particulate chicken and pumpkin coating product was made with ingredients in the proportions shown in Table 3 and by the process that follows.

TABLE 3

| INGREDIENTS | lbs. |
|---|---|
| Beef & Beef by-Products | 8.0 |
| Chicken & Chicken By-Products | 32.0 |
| Modified Starch (cross-linked) | 2.5 |
| Vitamin Premix | 0.01 |
| Mineral Premix | 0.06 |
| Color (caramel) | 0.25 |
| Pumpkin (dehydrated/ground) | 2.0 |
| Water | 55.18 |
| TOTAL | 100.0 |

The chicken and beef ingredients were ground through a plate with ⅜ inch holes on a Weiler grinder. Amounts of each were weighed as shown in Table 3 and added to a Reitz ribbon blender. With continuous mixing, all the other ingredients in Table 3, except the pumpkin, were added. The mixture was cooked while being blended to a temperature of 180° F. The blend was then emulsified through a Karl Schnell emulsion mill through 10 and 8 mm plates.

The ground (100% through US 14 mesh) dehydrated pumpkin was added to the emulsified mixture. The moisture of the mixture was 82.3%. This mixture was then filled into 425 mL metal cans, hermetically sealed, and retorted at 252° F. for 25 minutes then cooled to ambient temperature (about 70° F.). The viscosity of the cooled product was measured as described in Example 1 and was 3325 centipoise.

### Example 4

One hundred (100) pounds of a fine particulate chicken and apple coating product was made with ingredients in the proportions shown in Table 4 and by the process that follows.

TABLE 4

| INGREDIENTS | lbs. |
|---|---|
| Beef & Beef by-Products | 8.0 |
| Chicken & Chicken By-Products | 32.0 |
| Modified Starch (cross-linked) | 2.5 |
| Vitamin Premix | 0.01 |
| Mineral Premix | 0.06 |
| Color (caramel) | 0.25 |
| Apple (dehydrated/pulverized) | 2.0 |
| Water | 55.18 |
| TOTAL | 100.0 |

The chicken and beef ingredients were ground through a plate with ⅜ inch holes on a Weiler grinder. Amounts of each were weighed as shown in Table 4 and added to a Reitz ribbon blender. With continuous mixing, all the other ingredients in Table 4, except the apple, were added. The mixture was cooked while being blended to a temperature of 180° F. The blend was then emulsified through a Karl Schnell emulsion mill through 10 and 8 mm plates.

The pulverized (100% through US 14 mesh) dehydrated apple was added to the emulsified mixture. The moisture of the mixture was 81.9%. This mixture was then filled into 425 mL metal cans, hermetically sealed, and retorted at 252° F. for 25 minutes then cooled to ambient temperature (about 70° F.). The viscosity of the cooled product was measured as described in Example 1 and was 3375 centipoise.

### Example 5

One hundred (100) pounds of a fine particulate salmon and sweet potato coating product was made with ingredients in the proportions shown in Table 5 and by the process that follows.

TABLE 5

| INGREDIENTS | lbs. |
|---|---|
| Meat & Meat by-Products | 10.5 |
| Chicken & Chicken By-Products | 5.25 |
| Frozen Salmon | 26.25 |
| Modified Starch (cross-linked) | 2.6 |
| Vitamin Premix | 0.01 |
| Mineral Premix | 0.06 |
| Color (Red) | 0.05 |
| Titanium Dioxide | 0.3 |
| Sweet Potato (¼ inch cubes) | 1.66 |
| Water | 53.32 |
| TOTAL | 100.0 |

The frozen salmon, chicken and meat ingredients were ground through a plate with ⅜ inch holes on a Weiler grinder. Amounts of each were weighed as shown in Table 5 and added to a Reitz ribbon blender. With continuous mixing, all the other ingredients in Table 5 were added. The mixture was cooked while being blended to a temperature of 180° F. The blend was then emulsified through a Karl Schnell emulsion mill through 10 and 8 mm plates. The moisture of the mixture was 81.9%.

This mixture was then filled into 425 mL metal cans, hermetically sealed, and retorted at 252° F. for 25 minutes then cooled to ambient temperature (about 70° F.). The viscosity of the cooled product was measured as described in Example 1 was 3295 centipoise.

### Example 6

One hundred (100) pounds of a chunky carrot coating product was made with ingredients in the proportions shown in Table 6 and by the process that follows.

TABLE 6

| INGREDIENTS | lbs. |
|---|---|
| Xanthan Gum | 1.0 |
| Carrot Granule (⅛ inch) | 3.0 |
| Apple Powder | 5.0 |
| Water | 91.0 |
| TOTAL | 100.0 |

91 lbs. of water was heated to 95° F. in a jacketed stainless steel tank then

transferred to a Breddo Liqwifier that was set to 30 Hz. The remaining dry ingredients in Table 6 were combined in a bucket and slowly added to the water in the Breddo Liqwifier. The slurry was mixed for 4 minutes further after the addition of the dry ingredients. This mixture was then filled into 425 mL metal cans, hermetically sealed, and retorted at 252° F. for 25 minutes then cooled to ambient temperature (about 70° F.). The viscosity of the cooled product was measured as described in Example 1 was 3355 centipoise.

### Example 7

100 lbs. of berry blend coating product was made according to the formula shown in Table 7 as follows.

TABLE 7

| INGREDIENTS | lbs. |
|---|---|
| Modified Starch (cross- linked) | 4.0 |
| Dextrose | 0.3 |
| Glycine | 0.7 |
| Sodium Chloride | 0.85 |
| Mixed Berries Powder | 8.0 |
| Color (caramel) | 0.15 |
| Water (ambient - 70° F.) | 20.0 |
| Water (205° F.) | 65.8 |
| TOTAL | 100.0 |

The dry ingredients were measured and combined in a Cherry-Burrell stainless steel mixing tank. 20 lbs. of water at ambient temperature (70° F.) was added and mixing continued for 2 minutes to make a slurry.

Separately, 65.8 lbs. of tap water was placed in a steam jacketed stainless steel tank fitted with a Lightening Mixer and heated to 205° F. The slurry was then added to the heated water and mixed for 3 minutes to form a viscous but flowable mixture. This mixture was then filled into 425 mL metal cans, hermetically sealed, and retorted at 252° F. for 25 minutes then cooled to ambient (about 70° F.). Viscosity of the cooled product was measured as described in Example 1. The measured viscosity was 3210 centipoise.

### Example 8

100 lbs. of an apple and banana coating product was made according to the formula shown in Table 8 and by the process that follows.

TABLE 8

| INGREDIENTS | lbs. |
|---|---|
| Modified Starch (cross- linked) | 4.0 |
| Dextrose | 0.3 |
| Glycine | 0.7 |
| Sodium Chloride | 0.85 |
| Apple Powder | 4.0 |
| Banana Powder | 4.0 |
| Color (caramel) | 0.15 |
| Water (ambient - 70° F.) | 20.0 |
| Water (205° F.) | 65.8 |
| TOTAL | 100.0 |

The dry ingredients were measured and combined in a Cherry-Burrell stainless steel mixing tank. 20 lbs. of water at ambient temperature (70° F.) was added and mixing continued for 2 minutes to make a slurry.

Separately, 65.8 lbs. of tap water was placed in a steam jacketed stainless steel tank fitted with a Lightening Mixer and heated to 205° F. The slurry was then added to the heated water and mixed for 3 minutes to form a viscous but flowable mixture. This mixture was then filled into 425 mL metal cans, hermetically sealed, and retorted at 252° F. for 25 minutes then cooled to ambient temperature (about 70° F.). The viscosity of the cooled product was measured as described in Example 1. The measured viscosity was 3410 centipoise.

### Example 9

100 lbs. of an oatmeal and apple coating product was made according to the formula shown in Table 9 and by the process that follows.

TABLE 9

| INGREDIENTS | lbs. |
|---|---|
| Modified Starch (cross-linked) | 4.0 |
| Dextrose | 0.3 |
| Glycine | 0.7 |
| Sodium Chloride | 0.85 |
| Apple Powder | 4.0 |
| Oatmeal | 4.0 |
| Color (caramel) | 0.15 |
| Water (ambient - 70° F.) | 20.0 |
| Water (205° F.) | 65.8 |
| TOTAL | 100.0 |

The dry ingredients were measured and combined in a Cherry-Burrell stainless steel mixing tank. 20 lbs. of water at ambient temperature (70° F.) was added and mixing continued for 2 minutes to make a slurry.

Separately, 65.8 lbs. of tap water was placed in a steam jacketed stainless steel tank fitted with a Lightening Mixer and heated to 205° F. The slurry was then added to the heated water and mixed for 3 minutes to form a viscous but flowable mixture. This mixture was then filled into 425 mL metal cans, hermetically sealed, and retorted at 252° F. for 25 minutes then cooled to ambient temperature (about 70° F.). The viscosity of the cooled product was measured as described in Example 1. The measured viscosity was 3440 centipoise.

### Example 10

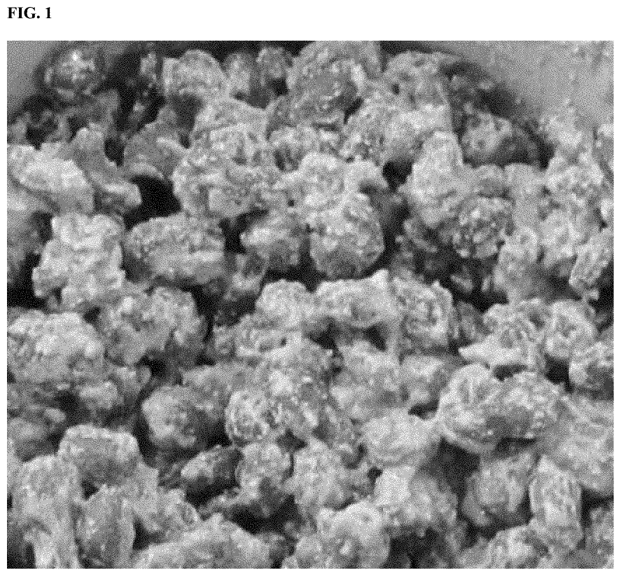

Palatability of dry dog food kibbles with the above coating formulations was measured as follows. 45 lbs. of freshly made standard dry dog food kibbles were added to a stainless steel tumble mixer. While the mixer was rotating, 5 lbs. of the beef and carrot coating product of Example 2 was slowly poured onto the dry kibbles and mixed for about 5 minutes until all kibbles appeared to be evenly coated as shown in FIG. 1. The coated product was immediately fed to a 20 dog panel in a standard paired comparison feeding versus the uncoated dry food kibbles from the same batch. The test was repeated with the test product being placed in the bowl opposite to that of the first feeding. Mean values for the two tests are shown in Table 10.

The palatability tests were repeated as described above for the coating composition from Examples 3, 4, 7, 8, and 9. The results are also shown in Table 10. The results clearly demonstrate that the coating compositions clearly improve the palatability of the kibbles relative to the un-coated dry kibbles.

TABLE 10

| | Exam- | Exam- | Exam- | Exam- | Exam- | Exam- |
|---|---|---|---|---|---|---|
| | ple | ple | ple | ple | ple | ple |
| | 2 | 3 | 4 | 7 | 8 | 9 |
| % Consumption | 91 | 93 | 90 | 89 | 92 | 92 |
| dry dog | | | | | | |
| food kibbles + | | | | | | |
| Test | | | | | | |
| Coating | | | | | | |
| % Consumption | 9 | 7 | 10 | 11 | 8 | 8 |
| of dry | | | | | | |
| dog food | | | | | | |
| kibbles only | | | | | | |

### Example 11

The effect of the coating on the crunchiness of the kibbles was measured by the maximum compressive force applied before the kibble fractures. An uncoated kibble was placed on a flat metal plate. Using an Instron 5500R texture analyzer fitted with a blunt T-probe, and with its crosshead travelling at 2 inches per minute, the maximum compression force (lbf) before the kibble fractured was determined. This determination was repeated with 19 kibbles. The mean compressive force for the 20 uncoated kibbles is shown in Table 11.

50 lbs. of coated products with the coating composition from Example 2 was made as described in Example 10. The coated product was placed in a covered container. Compression force was measured for 20 kibbles immediately after coating. The mean compressive force for Example 2 was then calculated. This was the time 0 reading shown in Table 11. Using new kibbles at each time intervals, the compressive force determination was repeated 30, 60, 90, 120 and 150 minutes after coating. The results are shown in Table 11.

This procedure was repeated with the coating composition from Example 5 and with a commercial product. Results are also shown in Table 11. The compressive forces clearly demonstrate that the test products retain their crunchiness longer than the commercial product.

TABLE 11

| Time | | Commercial | Example | Example |
|---|---|---|---|---|
| (Minutes | Dry | Product + Dry | 2 + Dry | 5 + Dry |
| after | Kibble | Kibbles | Kibbles | Kibbles |
| Coating) | (lbf) | (lbf) | (lbf) | (lbf) |
| 0 | 9.715 | 8.011 | 8.545 | 7.426 |
| 30 | | 5.428 | 6.675 | 5.599 |
| 60 | | 4.479 | 5.802 | 5.541 |
| 90 | | 3.32 | 5.801 | 5.362 |
| 120 | | 2.178 | 5.866 | 5.38 |
| 150 | | 1.72 | 5.892 | 5.36 |

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A coating composition that is a wet food product comprising water and an ingredient selected from the group consisting of a modified starch, a gum, and a combination thereof, and the composition has a viscosity of 2500 to 4000 centipoises as measured at room temperature.

2. The coating composition of claim 1 further comprising an additional ingredient selected from the group consisting of a flavor, a color, an antioxidant, a vitamin, a mineral, a non-replicating microorganism, a fiber, a prebiotic, and combinations thereof.

3. The coating composition of claim 1 further comprising an additional ingredient selected from the group consisting of an emulsified or particulate meat, an emulsified or particulate fruit, an emulsified or particulate vegetable, and combinations thereof.

4. The coating composition of claim 1 wherein the viscosity is 3000 to 3500 centipoises as measured at room temperature.

5. A method of making a coating composition comprising:
mixing water and an ingredient selected from the group consisting of a modified starch, a gum, and a combination thereof to form a mixture;
heating the mixture; and
pouring the heated mixture into a container that is then retorted, the retorted mixture has a viscosity of 2500 to 4000 centipoises as measured at room temperature.

6. The method of claim 5 wherein the mixture is heated to a temperature of at least 180° F. before pouring into the container.

7. The method of claim 5 wherein the heated mixture is homogenized before pouring into the container.

8. The method of claim 7 wherein at least one of a particulate fruit or a particulate vegetable is added to the mixture after homogenizing.

9. The method of claim 5 wherein a particulate meat is added to the mixture before the heating.

10. A method for preparing a pet food comprising adding a wet food product to a dry food product, the wet food product comprising water and an ingredient selected from the group consisting of a modified starch, a gum, and a combination thereof and having a viscosity of 2500 to 4000 centipoises as measured at room temperature.

11. The method of claim 10 wherein 10% to 15% of the wet food product is added to 85% to 90% dry food product, in reference to a final weight of the pet food.

12. The method of claim 10 wherein the dry food product comprises individual pieces, and the wet food product is added to the dry food product to coat each of the individual pieces of the dry food product with the wet food product.

13. The method of claim 12 wherein the individual pieces of the dry food product are coated with the wet food product without the individual pieces sticking together.

14. The method of claim 10 further comprising administering to a companion animal the pet food formed by addition of the wet food product to the dry food product.

15. The method of claim 10 wherein the dry food product maintains about the same maximum compressive force without breaking for at least 2.5 hours after addition of the wet food product.

16. A pet food comprising:
a dry food product; and
a coating composition on the dry food product, the coating composition is a wet food product comprising water and an ingredient selected from the group consisting of a modified starch, a gum, and a combination thereof, and the coating composition has a viscosity of 2500 to 4000 centipoises as measured at room temperature.

17. The pet food of claim 16 wherein the dry food product has a form of kibbles.

18. The pet food of claim 16 wherein an amount of the coating composition is 10% to 15% and an amount of the dry food product is 85% to 90%, in reference to a total weight of the pet food.

19. A kit comprising a wet food product stored separately from a dry food product, the wet food product comprising water and an ingredient selected from the group consisting of a modified starch, a gum, and a combination thereof and having a viscosity of 2500 to 4000 centipoises as measured at room temperature.

20. A pet feeding system comprising a plurality of pet food coating compositions, each of the coating compositions is a wet food product comprising water and an ingredient selected from the group consisting of a modified starch, a gum, and a combination thereof and having a viscosity of 2500 to 4000 centipoises as measured at room temperature, and a first subset of the coating compositions has a different texture relative to a second subset of the coating compositions.
